(19) United States
(12) Patent Application Publication
(10) Pub. No.: US 2024/0212316 A1
(43) Pub. Date: Jun. 27, 2024

(54) ORIGINAL IMAGE EXTRACTION FROM HIGHLY-SIMILAR DATA

(71) Applicant: INTERNATIONAL BUSINESS MACHINES CORPORATION, Armonk, NY (US)

(72) Inventors: Peter Christopher Gramenides, Kingston, NY (US); Vijai Kalathur, Wappingers Falls, NY (US); Michael Andrasak, Red Hook, NY (US); Ashish Deshpande, Hopewell Junction, NY (US); Peter J. Rooney, Poughquag, NY (US); Gary R. Picher, Wappingers Falls, NY (US)

(21) Appl. No.: 18/146,328

(22) Filed: Dec. 23, 2022

(51) Int. Cl. G06V 10/762; G06V 10/75; G06V 10/778

(52) U.S. Cl. CPC G06V 10/762; G06V 10/751; G06V 10/7788

(57) ABSTRACT

A computer hardware system includes a processor including a comparison engine and configured to perform the following executable operations. Using the comparison engine, each image in a dataset of highly-similar images is compared to every other image in the dataset of highly-similar images to generate a comparison score for each image-image pair. The images in the dataset of highly-similar images are clustered into a plurality of image clusters based upon the comparison scores. One of the plurality of image clusters is selected as representing an original image. A data processing operation is performed on the dataset of highly-similar images based upon the selection of the one of the plurality of image clusters as representing the original image.

### BACKGROUND

The present invention relates to image evaluation, and more specifically, to identifying duplicated and modified images from a set of highly-similar images.

With the rise of social media and the mass proliferation of trends, hashtags, and image editing software, there has been a rise of tampered images, many of which are modified ever so slightly from their original form. Identifying these tampered with images has become a technical challenge for the companies that host these images. Some companies have approached this issue using a brute force method of employing thousands of employees with the specific purpose of monitoring their platforms. Deep fake and forgery detection algorithms have been employed but have not shown to be consistently highly-accurate in differentiating between highly-similar datasets of images. Additionally, these methodologies are oftentimes ineffective with dealing with highly-skilled forgeries.

### SUMMARY

A computer-implemented process within a computer hardware system having a comparison engine includes the following executable operations. Using the comparison engine, each image in a dataset of highly-similar images is compared to every other image in the dataset of highly-similar images to generate a comparison score for each image-image pair. The images in the dataset of highly-similar images are clustered into a plurality of image clusters based upon the comparison scores. One of the plurality of image clusters is selected as representing an original image. A data processing operation is performed on the dataset of highly-similar images based upon the selection of the one of the plurality of image clusters as representing the original image.

In further aspects of the process, the selecting is performed by a machine learning engine. Also, the selecting can include providing a graphical user interface configured to: visually display a plurality of images respectively representing each of the plurality of image clusters; and receive a selection indicating the one of the plurality of image clusters as representing the original image. The graphical user interface can be further configured to present the plurality of images as a radial cluster and display one or more differences between respective images associated with a pair of selected clusters. The data processing operation can include deleting images in the dataset of highly-similar images not corresponding to the selected one of the plurality of image clusters as representing the original image or tagging images in the dataset of highly-similar images not corresponding to the selected one of the plurality of image clusters as representing the original image. The tagging includes adding a link to the original image within metadata associated with each of the images in the dataset of highly-similar images not corresponding to the selected one of the plurality of image clusters as representing the original image.

A computer hardware system includes a hardware processor having a comparison engine and is configured to perform the following executable operations. Using the comparison engine, each image in a dataset of highly-similar images is compared to every other image in the dataset of highly-similar images to generate a comparison score for each image-image pair. The images in the dataset of highly-similar images are clustered into a plurality of image clusters based upon the comparison scores. One of the plurality of image clusters is selected as representing an original image. A data processing operation is performed on the dataset of highly-similar images based upon the selection of the one of the plurality of image clusters as representing the original image.

In further aspects of the system, the selecting is performed by a machine learning engine. Also, the selecting can include providing a graphical user interface configured to: visually display a plurality of images respectively representing each of the plurality of image clusters; and receive a selection indicating the one of the plurality of image clusters as representing the original image. The graphical user interface can be further configured to present the plurality of images as a radial cluster and display one or more differences between respective images associated with a pair of selected clusters. The data processing operation can include deleting images in the dataset of highly-similar images not corresponding to the selected one of the plurality of image clusters as representing the original image or tagging images in the dataset of highly-similar images not corresponding to the selected one of the plurality of image clusters as representing the original image. The tagging includes adding a link to the original image within metadata associated with each of the images in the dataset of highly-similar images not corresponding to the selected one of the plurality of image clusters as representing the original image.

A computer program product includes computer readable storage medium having stored therein program code. The program code, which when executed by a computer hardware system including a comparison engine, cause the computer hardware system to perform the following operations. Using the comparison engine, each image in a dataset of highly-similar images is compared to every other image in the dataset of highly-similar images to generate a comparison score for each image-image pair. The images in the dataset of highly-similar images are clustered into a plurality of image clusters based upon the comparison scores. One of the plurality of image clusters is selected as representing an original image. A data processing operation is performed on the dataset of highly-similar images based upon the selection of the one of the plurality of image clusters as representing the original image.

In further aspects of the computer program product, the selecting is performed by a machine learning engine. Also, the selecting can include providing a graphical user interface configured to: visually display a plurality of images respectively representing each of the plurality of image clusters; and receive a selection indicating the one of the plurality of image clusters as representing the original image. The graphical user interface can be further configured to present the plurality of images as a radial cluster and display one or more differences between respective images associated with a pair of selected clusters. The data processing operation can include deleting images in the dataset of highly-similar images not corresponding to the selected one of the plurality of image clusters as representing the original image or tagging images in the dataset of highly-similar images not corresponding to the selected one of the plurality of image clusters as representing the original image. The tagging includes adding a link to the original image within metadata associated with each of the images in the dataset of highly-similar images not corresponding to the selected one of the plurality of image clusters as representing the original image.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 is a block diagram illustrating an architecture of an example original image detection system according to an embodiment of the present invention.

FIG. 2 illustrates an example method using the architecture of FIG. 1 according to an embodiment of the present invention.

FIGS. 3A-C respectively illustrate an original image, a modified image, and a greyscale representation of differences between the original image and the modified image.

FIG. 4 illustrates a radial cluster diagram illustrating clustering of images.

FIG. 5 illustrates an example graphical user interface for use with the architecture of FIG. 1 according to an embodiment of the present invention.

FIG. 6 illustrates a further aspect of the graphical user interface of FIG. 5 according to an embodiment of the present invention.

FIG. 7 is a block diagram illustrating an example of computer environment for implementing portions of the methodology of FIG. 2.

### DETAILED DESCRIPTION

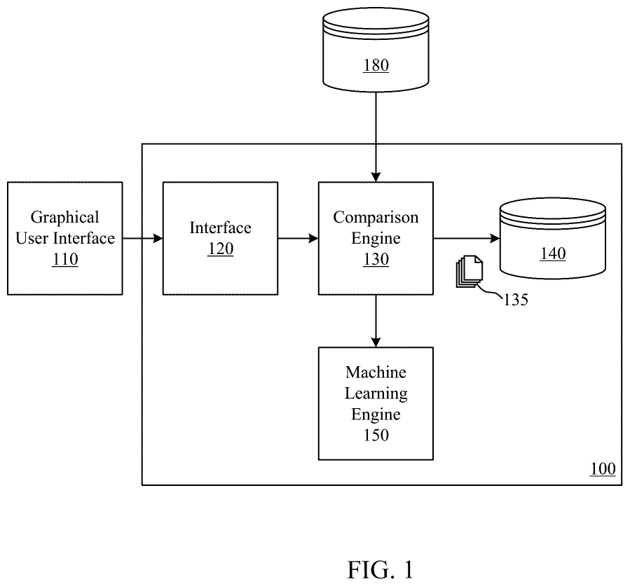

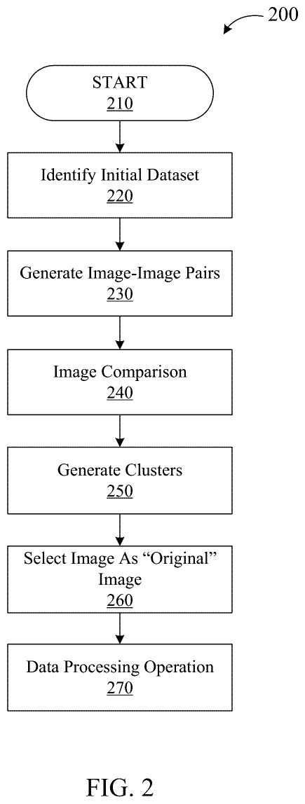

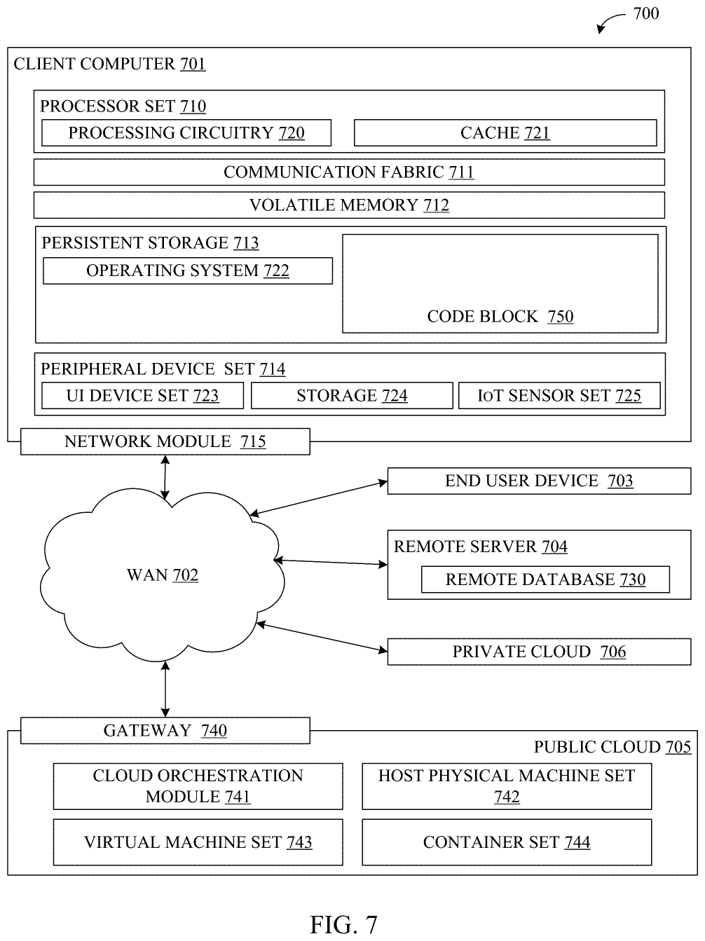

Reference is made to FIG. 1 and FIG. 2, which respectively illustrate an original image detection system 100 and methodology 200 for detecting an original image from a set of highly-similar images. Although not limited in this manner, the original image detection system 100 includes one or more of storage 140, 180, an interface 120 configured to interact with a graphical user interface 110 within a client computer, a comparison engine 130, and a machine learning engine 150. Although illustrated as being within a single system 100, the individual components of the original image detection system 100 can be distributed over a plurality of computer devices. For example, the storage 140, 180 could be stored on different computers (not shown) and remotely accessed. Additionally, the machine learning engine 150 could be within a standalone computer system (not shown) or located in a cloud computing system such as described in FIG. 7.

Although discussed in more detail below, in certain aspects, using the comparison engine 130, each image in a dataset of highly-similar images from storage 180 is compared to every other image in the dataset of highly-similar images to generate a comparison score for each image-image pair. The images in the dataset of highly-similar images are clustered into a plurality of image clusters based upon the comparison scores. One of the plurality of image clusters is then selected as representing an original image. A data processing operation is then performed on the dataset of highly-similar images based upon the selection of the one of the plurality of image clusters as representing the original image.

In 210, the process 200 begins. In 220, the comparison engine 130 retrieves a set of highly-similar images previously-stored, for example, in data storage 180. The data storage 180 can be internal to the original image detection system 100 or located externally, for example, at a server system that hosts webpages/websites that include the dataset of highly-similar images. As used herein, the term “highly-similar images” refers to a plurality of images that are determined to have a pre-determined percentage of the image as being identical to another image in the plurality of images. This pre-determined percentage can vary. However, in certain aspects, at least 75% of the images, when a pixel-by-pixel comparison is performed from one image to another image, are identical, and in other aspects, at least 90% of the images when a pixel-by-pixel comparison is performed from one image to another image, are identical. Different approaches capable of determining whether certain portions of images are identical are known, and the comparison engine 130 is not limited as to a particular approach.

The manner by which the set of highly-similar images is collected is not limited to a particular approach. One approach, for example, may include relying upon a metatag (e.g., hashtags) associated with the images within the set. Another approach can include providing a computer tool for users to report certain images suspected as being altered. Automated approaches for gathering similar images can also be employed.

In 230, image-image pairs are generated. As used, herein the term “image-image pair” refers to a particular computer data structure that identifies a paired set of two images in the dataset of highly-similar images. In certain aspects, image-image pairs are created for all of the images in the dataset. In other words, image-image pairs are created when a first image is paired with every other image. A next image is then paired with every other image. This is performed recursively until all images are in the dataset are paired together. Ultimately, each image-image pair represents a unique paired-set of two images from the dataset. For example, if there were 10 unique images in the set of highly-similar images, 45 unique image-image pairs would be created. By way of another example, if there were 100 unique images in the set of high-similar images 4950 unique image-image pairs would be created.

In 240, the images associated with the image-image pairs are compared using the comparison engine 130. Many different approaches for comparing images are known, and the comparison engine 130 is not limited as to a particular approach. The comparison engine 130 can employ machine learning (e.g., via the machine learning engine) to perform comparisons of the image-image pairs. Exemplary type of machine learning techniques include Single Shot Detection (SSD), Faster Region based Convolutional Neural Networks (Faster R-CNN), and You Only Look Once (Yolo). However, a machine learning approach can be resource heavy.

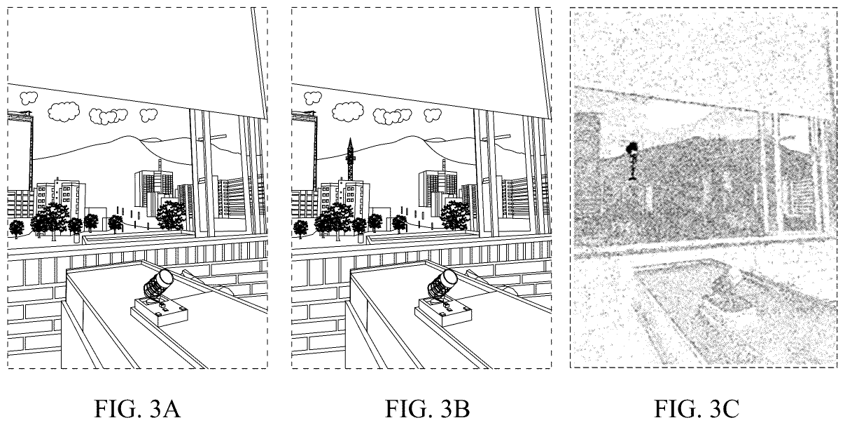

In certain aspects, the comparison engine 130 employs an imgcompare algorithm. With reference to FIG. 3A-3C, an original image (FIG. 3A) and a modified image (FIG. 3B) are compared using the imgcompare algorithm. The imgcompare algorithm compares the first image to the second image to identify the differences there between, which results in a difference image. The difference image is then converted into a grayscale difference image and a black-and-white difference image (FIG. 3C). Histogram values of the pixels of the grayscale image are then summed. According to the imgcompare algorithm, a percentage difference is then determined between the sum of the histogram values and a black-and-white image of the same size. Although the imgcompare algorithm uses this particular approach for determining a difference image, other types of approaches for generating a difference image are known. Accordingly, on other aspects of the original image detection system 100, the comparison engine 130 can be configured to use any one of these other types of approaches.

Depending upon the approach employed, the result of the comparison results in a value (i.e., a “comparison score”) that is indicative of the similarity of (or difference between) the two images in the image-image pair. This comparison score is then recorded with the particular image-image pair, and this combined data structure 135 can be stored within local storage 140. An example of this combined data structure 135 is listed below in TABLE I, which shows the identifier of the image-image pair in the first row and the respective comparison score in the second row.

In 250, the images in the set of highly-similar images are clustered into a plurality of image clusters based upon the comparison scores. This operation can be performed by the comparison engine 130 or by a separate clustering engine (not shown). Each image cluster contains visually identical images that have little to no discernable difference. For example, the following table refers to 5 images labeled A, B, C, D, E. The first row indicates the particular image-image pair and the second row indicates a similarity score associated with the image-image pair where a lower number represents a more similar image:

TABLE I

| A-B | A-C | A-D | A-E | B-C | B-D | B-E | C-D | C-E | D-E |
|---|---|---|---|---|---|---|---|---|---|
| .057 | .062 | .015 | .005 | .004 | .083 | .062 | .081 | .065 | .016 |

By way of example and assuming that a cutoff value for determining an image cluster is 0.006, then the 5 images labeled A, B, C, D, E can be clustered together in three clusters. A first image cluster is images A and E. A second image cluster is images B and C. A third image cluster is image D. As can be seen, the third cluster contains a smaller change relative to the first image cluster than the second image cluster. Had the cutoff value been higher (e.g., 0.020), then image D would have been contained in the first image cluster. As such, varying the cutoff value can change the size of the image clusters. Also, even otherwise “identical” images can contain some slight differences, e.g., based upon the compression algorithms used to create the images, and consequently, varying the cutoff value can accommodate for these slight differences while still creating image clusters that represent distinct images. This cutoff value can be set by the user using the graphical user interface 110 and/or preset. Additionally, the present cutoff value can be determined using the machine learning engine 150 and continually modified based upon reinforced learning.

This approach to distinguishing between highly-similar images can also be used to identify the dataset of highly-similar images in 220. Specifically, by setting the cutoff value for the image at a sufficiently higher value, the dataset of high-similar images can be generated. For example, if an original dataset of images obtained at 220 includes both highly-similar and substantially-different images, setting the cutoff value for an image cluster at 0.090, for example, would cluster all of the 5 images into a single image cluster, which would serve as the dataset of highly-similar images. Once this dataset of high-similar images is generated, the process can be repeated to cluster each of the 5 images into clusters, as discussed above.

In 260, one of the plurality of image clusters is selected as representing the original image. The original image detection system 310 is not limited as to a particular approach for making this selection. For example, the selecting can be performed automatically using the machine learning engine 150. Also, the selecting can be performed with the aid of the graphical user interface 110, which allows a user to make the selection. As another alterative, the selecting can be performed using a combination of the machine learning engine 150 and the graphical user interface 110.

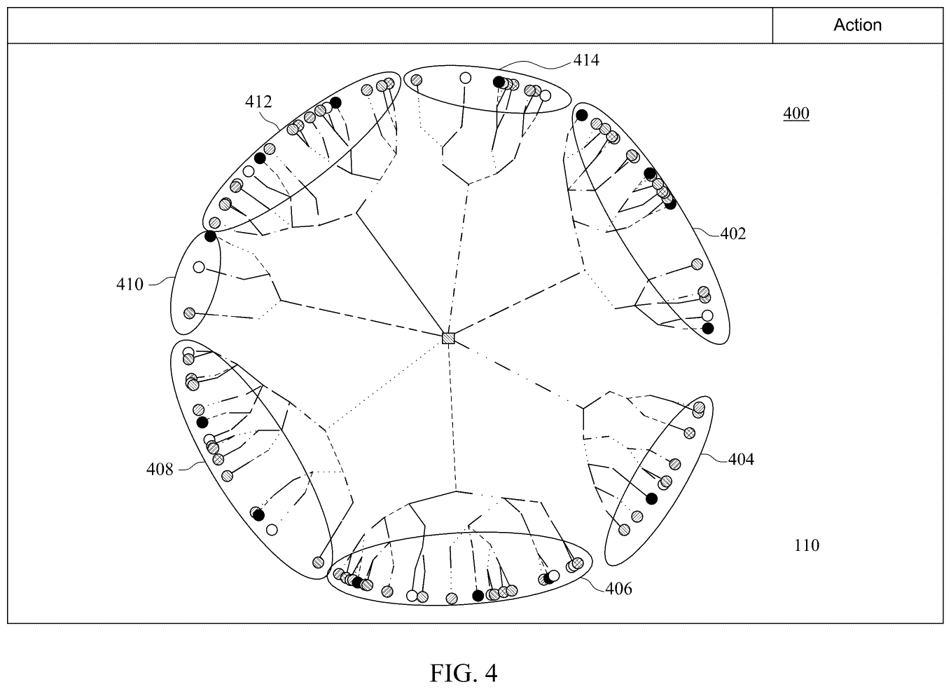

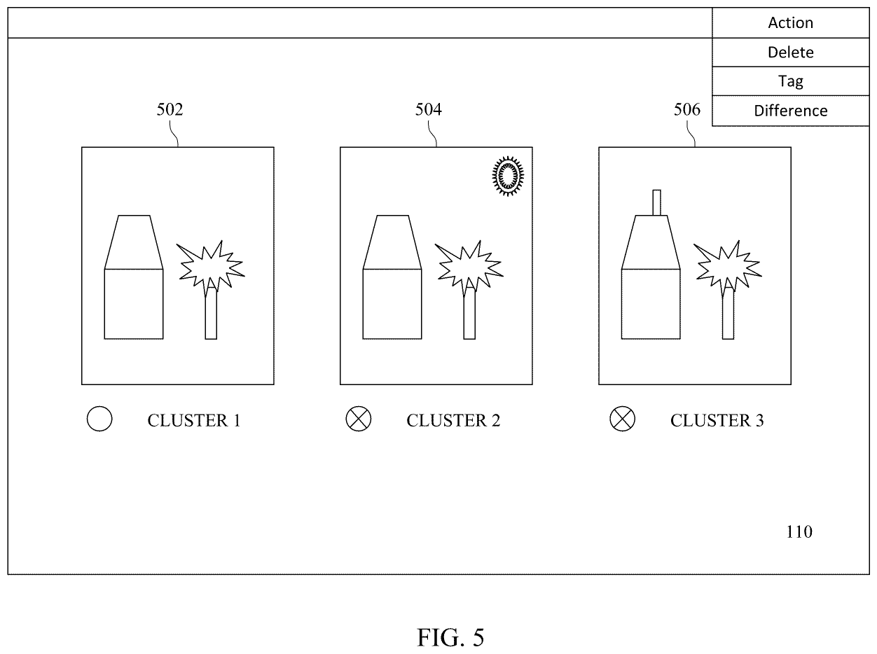

FIGS. 4-6 illustrate aspects of the graphical user interface 110. In FIG. 4, the individual image clusters 402-414 can be displayed as part of a radial cluster diagram 400. A user can then select a plurality of these image clusters 402-414 to be displayed, and with reference to FIG. 5, representative images 502, 504, 506 of the selected image clusters can be visually displayed. The machine learning engine 150 can be used to automatically select one of the plurality of image clusters as presenting the original image. Alternatively, the machine learning engine 150 can be used to suggest to the user, via the graphical user interface 110, that one of the image clusters is suspected as being the original image while allowing the user to make a selection as to what image cluster is considered to represent the original image. In this instance, the machine learning engine 150 can be trained based upon the user's selection.

In 270, data processing operations can be performed on the set of highly-similar images. For example, a “Delete” operation can be performed, which involves deleting images in the set of highly-similar images not corresponding to the image cluster that was selected as representing the original image. The deleting can also involve replacing the image determined not to be the original image with the suspected original image.

As another example of a data processing operation, a “Tag” operation can be performed, which involves tagging images in the set of highly-similar images not corresponding to the image cluster that was selected as representing the original image. This tagging can involve, for example, adding metadata to the image, which can cause subsequent display of the image to indicate that the image is suspected as not being an unmodified (i.e., original) image. Additionally, the tagging can also include a link in the metadata to an original image. In this manner, display of the suspected modified image can also provide a user to link to and view the suspected unmodified image.

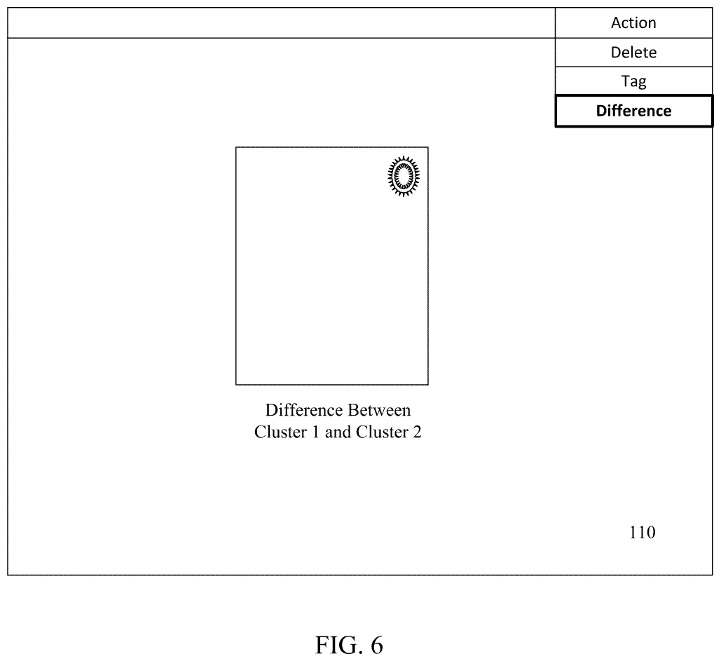

With reference to FIG. 6, the graphical user interface 110 can also provide a user to visualize the differences between two selected images. By way of example, the difference between image cluster 1 and image cluster 2 from FIG. 5 is the existence of a sun in image cluster 2 that is not contained in cluster 1. The displaying of these differences can aid the user in determining which of the plurality of image clusters represents the original image.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “real time” means a level of processing responsiveness that a user or system senses as sufficiently immediate for a particular process or determination to be made, or that enables the processor to keep up with some external process.

As defined herein, the term “automatically” means without user intervention.

Referring to FIG. 7, computing environment 700 contains an example of an environment for the execution of at least some of the computer code involved in performing the inventive methods, such as code block 750 for implementing the operations of the original image detection system 100. Computing environment 700 includes, for example, computer 701, wide area network (WAN) 702, end user device (EUD) 703, remote server 704, public cloud 705, and private cloud 706. In certain aspects, computer 701 includes processor set 710 (including processing circuitry 720 and cache 721), communication fabric 711, volatile memory 712, persistent storage 713 (including operating system 722 and method code block 750), peripheral device set 714 (including user interface (UI), device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

Computer 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. However, to simplify this presentation of computing environment 700, detailed discussion is focused on a single computer, specifically computer 701. Computer 701 may or may not be located in a cloud, even though it is not shown in a cloud in FIG. 7 except to any extent as may be affirmatively indicated.

Processor set 710 includes one, or more, computer processors of any type now known or to be developed in the future. As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In certain computing environments, processor set 710 may be designed for working with qubits and performing quantum computing.

Computer readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods discussed above in this document (collectively referred to as “the inventive methods”). These computer readable program instructions are stored in various types of computer readable storage media, such as cache 721 and the other storage media discussed below. The program instructions, and associated data, are accessed by processor set 710 to control and direct performance of the inventive methods. In computing environment 700, at least some of the instructions for performing the inventive methods may be stored in code block 750 in persistent storage 713.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Communication fabric 711 is the signal conduction paths that allow the various components of computer 701 to communicate with each other. Typically, this communication fabric 711 is made of switches and electrically conductive paths, such as the switches and electrically conductive paths that make up busses, bridges, physical input/output ports and the like. Other types of signal communication paths may be used for the communication fabric 711, such as fiber optic communication paths and/or wireless communication paths.

Volatile memory 712 is any type of volatile memory now known or to be developed in the future. Examples include dynamic type random access memory (RAM) or static type RAM. Typically, the volatile memory 712 is characterized by random access, but this is not required unless affirmatively indicated. In computer 701, the volatile memory 712 is located in a single package and is internal to computer 701. In addition to alternatively, the volatile memory 712 may be distributed over multiple packages and/or located externally with respect to computer 701.

Persistent storage 713 is any form of non-volatile storage for computers that is now known or to be developed in the future. The non-volatility of the persistent storage 713 means that the stored data is maintained regardless of whether power is being supplied to computer 701 and/or directly to persistent storage 713. Persistent storage 713 may be a read only memory (ROM), but typically at least a portion of the persistent storage 713 allows writing of data, deletion of data and re-writing of data. Some familiar forms of persistent storage 713 include magnetic disks and solid state storage devices. Operating system 722 may take several forms, such as various known proprietary operating systems or open source Portable Operating System Interface type operating systems that employ a kernel. The code included in code block 750 typically includes at least some of the computer code involved in performing the inventive methods.

Peripheral device set 714 includes the set of peripheral devices for computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet.

In various aspects, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some aspects, storage 724 may take the form of a quantum computing storage device for storing data in the form of qubits. In aspects where computer 701 is required to have a large amount of storage (for example, where computer 701 locally stores and manages a large database) then this storage 724 may be provided by peripheral storage devices designed for storing very large amounts of data, such as a storage area network (SAN) that is shared by multiple, geographically distributed computers. Internet-of-Things (IOT) sensor set 725 is made up of sensors that can be used in IoT applications. For example, one sensor may be a thermometer and another sensor may be a motion detector.

Network module 715 is the collection of computer software, hardware, and firmware that allows computer 701 to communicate with other computers through a Wide Area Network (WAN) 702. Network module 715 may include hardware, such as modems or Wi-Fi signal transceivers, software for packetizing and/or de-packetizing data for communication network transmission, and/or web browser software for communicating data over the internet. In certain aspects, network control functions and network forwarding functions of network module 715 are performed on the same physical hardware device. In other aspects (for example, aspects that utilize software-defined networking (SDN)), the control functions and the forwarding functions of network module 715 are performed on physically separate devices, such that the control functions manage several different network hardware devices. Computer readable program instructions for performing the inventive methods can typically be downloaded to computer 701 from an external computer or external storage device through a network adapter card or network interface included in network module 715.

WAN 702 is any Wide Area Network (for example, the internet) capable of communicating computer data over non-local distances by any technology for communicating computer data, now known or to be developed in the future. In some aspects, the WAN 702 ay be replaced and/or supplemented by local area networks (LANs) designed to communicate data between devices located in a local area, such as a Wi-Fi network. The WAN 702 and/or LANs typically include computer hardware such as copper transmission cables, optical transmission fibers, wireless transmission, routers, firewalls, switches, gateway computers and edge servers.

End user device (EUD) 703 is any computer system that is used and controlled by an end user (for example, a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In certain aspects, EUD 703 may be a client device, such as thin client, heavy client, mainframe computer, desktop computer and so on.

As defined herein, the term “client device” means a data processing system that requests shared services from a server, and with which a user directly interacts. Examples of a client device include, but are not limited to, a workstation, a desktop computer, a computer terminal, a mobile computer, a laptop computer, a netbook computer, a tablet computer, a smart phone, a personal digital assistant, a smart watch, smart glasses, a gaming device, a set-top box, a smart television and the like. Network infrastructure, such as routers, firewalls, switches, access points and the like, are not client devices as the term “client device” is defined herein. As defined herein, the term “user” means a person (i.e., a human being).

Remote server 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704. As defined herein, the term “server” means a data processing system configured to share services with one or more other data processing systems.

Public cloud 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702.

VCEs can be stored as “images,” and a new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 706 is similar to public cloud 705, except that the computing resources are only available for use by a single enterprise. While private cloud 706 is depicted as being in communication with WAN 702, in other aspects, a private cloud 706 may be disconnected from the internet entirely (e.g., WAN 702) and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this aspect, public cloud 705 and private cloud 706 are both part of a larger hybrid cloud.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

As another example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. Each block in the flowchart or block diagrams may represent a module, segment, or portion of instructions, which comprises one or more executable instructions for implementing the specified logical function(s).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes.” “including.” “comprises,” and/or “comprising.” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” “one arrangement,” “an arrangement.” “one aspect,” “an aspect,” or similar language means that a particular feature, structure, or characteristic described in connection with the embodiment is included in at least one embodiment described within this disclosure. Thus, appearances of the phrases “one embodiment,” “an embodiment,” “one arrangement,” “an arrangement,” “one aspect.” “an aspect,” and similar language throughout this disclosure may, but do not necessarily, all refer to the same embodiment.

The term “plurality,” as used herein, is defined as two or more than two. The term “another.” as used herein, is defined as at least a second or more. The term “coupled.” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “if,” “when,” “upon,” “in response to,” and the like are not to be construed as indicating a particular operation is optional. Rather, use of these terms indicate that a particular operation is conditional. For example and by way of a hypothetical, the language of “performing operation A upon B” does not indicate that operation A is optional. Rather, this language indicates that operation A is conditioned upon B occurring.

The foregoing description is just an example of embodiments of the invention, and variations and substitutions. While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

What is claimed is:

1. A computer-implemented method within a computer hardware system including a comparison engine, comprising:
comparing, using the comparison engine, each image in a dataset of highly-similar images to every other image in the dataset of highly-similar images to generate a comparison score for each image-image pair;
clustering the images in the dataset of highly-similar images into a plurality of image clusters based upon the comparison scores;
selecting one of the plurality of image clusters as representing an original image; and
performing a data processing operation on the dataset of highly-similar images based upon the selecting.

2. The method of claim 1, wherein
the selecting is performed by a machine learning engine.

3. The method of claim 1, wherein
the selecting includes providing a graphical user interface configured to:
visually display a plurality of images respectively representing each of the plurality of image clusters; and
receive a selection indicating the one of the plurality of image clusters as representing the original image.

4. The method of claim 3, wherein
the graphical user interface is further configured to present the plurality of images as a radial cluster.

5. The method of claim 3, wherein
the graphical user interface is further configured to display one or more differences between respective images associated with a pair of selected clusters.

6. The method of claim 1, wherein
the data processing operation includes deleting images in the dataset of highly-similar images not corresponding to the selected one of the plurality of image clusters as representing the original image.

7. The method of claim 1, wherein
the data processing operation includes tagging images in the dataset of highly-similar images not corresponding to the selected one of the plurality of image clusters as representing the original image.

8. The method of claim 7, wherein
the tagging includes adding a link to the original image within metadata associated with each of the images in the dataset of highly-similar images not corresponding to the selected one of the plurality of image clusters as representing the original image.

9. A computer hardware system, comprising:
a hardware processor including a comparison engine and configured to perform the following executable operations:
comparing, using the comparison engine, each image in a dataset of highly-similar images to every other image in the dataset of highly-similar images to generate a comparison score for each image-image pair;
clustering the images in the dataset of highly-similar images into a plurality of image clusters based upon the comparison scores;
selecting one of the plurality of image clusters as representing an original image; and
performing a data processing operation on the dataset of highly-similar images based upon the selecting.

10. The system of claim 9, wherein
the selecting is performed by a machine learning engine.

11. The system of claim 9, wherein
the selecting includes providing a graphical user interface configured to:
visually display a plurality of images respectively representing each of the plurality of image clusters; and
receive a selection indicating the one of the plurality of image clusters as representing the original image.

12. The system of claim 11, wherein
the graphical user interface is further configured to present the plurality of images as a radial cluster.

13. The system of claim 11, wherein
the graphical user interface is further configured to display one or more differences between respective images associated with a pair of selected clusters.

14. The system of claim 9, wherein
the data processing operation includes deleting images in the dataset of highly-similar images not corresponding to the selected one of the plurality of image clusters as representing the original image.

15. The system of claim 9, wherein
the data processing operation includes tagging images in the dataset of highly-similar images not corresponding to the selected one of the plurality of image clusters as representing the original image.

16. The system of claim 15, wherein
the tagging includes adding a link to the original image within metadata associated with each of the images in the dataset of highly-similar images not corresponding to the selected one of the plurality of image clusters as representing the original image.

17. A computer program product, comprising:
a computer readable storage medium having stored therein program code,
the program code, which when executed by the computer hardware system including a comparison engine, cause the computer hardware system to perform:
comparing, using the comparison engine, each image in a dataset of highly-similar images to every other image in the dataset of highly-similar images to generate a comparison score for each image-image pair;
clustering the images in the dataset of highly-similar images into a plurality of image clusters based upon the comparison scores;
selecting one of the plurality of image clusters as representing an original image; and
performing a data processing operation on the dataset of highly-similar images based upon the selecting.

18. The computer program product of claim 17, wherein
the selecting includes providing a graphical user interface configured to:
visually display a plurality of images respectively representing each of the plurality of image clusters; and
receive a selection indicating the one of the plurality of image clusters as representing the original image.

19. The computer program product of claim 17, wherein
the data processing operation includes tagging images in the dataset of highly-similar images not corresponding to the selected one of the plurality of image clusters as representing the original image.

20. The computer program product of claim 19, wherein
the tagging includes adding a link to the original image within metadata associated with each of the images in the dataset of highly-similar images not corresponding to the selected one of the plurality of image clusters as representing the original image.
